(19) United States
(12) Patent Application Publication
(10) Pub. No.: US 2012/0042771 A1
(43) Pub. Date: Feb. 23, 2012

(54) ELECTRONICALLY CONTROLLED VALVE

(75) Inventors: Fergus Robert Mcintyre, Edinburgh (GB); Michael Richard Fielding, Edinburgh (GB); Uwe Bernhard Pascal Stein, Edinburgh (GB)

(73) Assignee: ARTEMIS INTELLIGENT POWER LIMITED, Midlothian (GB)

(21) Appl. No.: 13/318,654

(22) PCT Filed: Nov. 15, 2010
(86) PCT No.: PCT/GB2010/051902

§ 371 Date: Nov. 3, 2011

(30) Foreign Application Priority Data
Nov. 13, 2009 (EP) 09014214.2

(51) Int. Cl. F15B 13/04; F16K 31/02

(52) U.S. Cl. 91/418; 251/129.01; 137/1; 91/471

(57) ABSTRACT

An electronically controlled valve includes a valve member moveable between a first position and a second position. A valve member moving mechanism is operable to receive energy from a fluid-working machine crankshaft, or other rotating shaft, and to provide a valve member moving force to urge the valve member from the first position to the second position using the received energy. Thus, the energy used for movement of the valve against a pressure gradient is derived from the crankshaft. Energy received from the crankshaft can be stored and used subsequently to urge the valve member from the first position, allowing the valve to function despite timing differences between the availability of energy from the crankshaft and the requirement for energy to move the valve member.

### FIELD OF THE INVENTION

The invention relates to the field of electronically controlled valves which are suitable for regulating the flow of fluid between a manifold and a working chamber of a fluid-working machine. The invention is applicable to fluid-working machines which have a rotating shaft, including but not limited to a crankshaft.

### BACKGROUND TO THE INVENTION

It is known to provide fluid-working machines, such as pumps, motors and machines which operate as either a pump or a motor, which include a rotating shaft and one or more working chambers which are in mechanical communication with the rotating shaft such that their volume varies cyclically with rotation of the shaft, in which the flow of fluid between the working chambers and one or more manifolds is regulated by electronically controlled valves. Such fluid working machines comprise at least one rotary to linear motion linking mechanism such as an eccentric cam, wobble plate or hollow cam, including separable hollow cams.

For example, fluid-working machines are known which comprise a crankshaft and a plurality of working chambers of cyclically varying volume, in which the displacement of fluid through the working chambers is regulated by electronically controllable valves, on a cycle by cycle basis and in phased relationship to cycles of working chamber volume, to determine the net throughput of fluid through the machine. For example, EP 0 361 927 disclosed a method of controlling the net throughput of fluid through a multi-chamber pump by opening and/or closing electronically controllable poppet valves, in phased relationship to cycles of working chamber volume, to regulate fluid communication between individual working chambers of the pump and a low pressure manifold. As a result, individual chambers are selectable by a controller, on a cycle by cycle basis, to either displace a predetermined fixed volume of fluid or to undergo an idle cycle with no net displacement of fluid, thereby enabling the net throughput of the pump to be matched dynamically to demand. EP 0 494 236 developed this principle and included electronically controllable poppet valves which regulate fluid communication between individual working chambers and a high pressure manifold, thereby facilitating the provision of a fluid-working machine which functions as a motor or which functions as either a pump or a motor in alternative operating modes. EP 1 537 333 introduced the possibility of part cycles, allowing individual cycles of individual working chambers to displace any of a plurality of different volumes of fluid to better match demand. Instead of dedicated high pressure and low pressure ports, a fluid working machine may have interchangeable ports, for example, as disclosed in U.S. Pat. No. 6,651,545.

Fluid-working machines of this type require rapidly opening and closing electronically controllable valves capable of regulating the flow of fluid into and out of a working chamber from the low pressure manifold, and in some embodiments, the high pressure manifold. The electronically controllable valves are typically actively controlled, for example, actively opened, actively closed, or actively held open or closed against a pressure differential, under the active control of the controller. Although all opening or closing of an actively controlled valve may be under the active control of a controller, it is usually preferable for at least some opening or closing of the actively controlled valves to be passive. For example, the actively controlled low pressure valve disclosed in the fluid-working machines described above may open passively when the pressure in a working chamber falls below the pressure of the low pressure manifold, but be optionally actively held open to create an idle cycle or actively closed during a motoring cycle, just before top dead centre, to build up sufficient pressure within the working chamber to enable the high pressure valve to open.

The active control can consume a significant amount of electrical power. In the type of fluid-working machine described above, actively controlled opening or closing of a valve requires the valve member, which has a significant mass, to be moved between a first position and a second position in a very short period of time, for example, a few milliseconds, which can consume a significant amount of energy.

Thus, the invention aims to provide electronically controlled valves and fluid-working machines including electronically controlled valves which consume less electrical energy than would otherwise be the case, thereby providing fluid-working machines which are, as a whole, more energy efficient and easier to control.

In the present invention, this is achieved by receiving energy from a fluid-working machine crankshaft and using the energy received from the crankshaft to provide a valve member moving force to urge the valve member from the first position to the second position. A difficulty with the implementation of this strategy is that, in some embodiments, the availability of energy from the crankshaft does not coincide with the time when the valve member is to be urged from the first position to the second position. Accordingly, some embodiments of the invention address the further problem of the difference in timing between availability of energy from the crankshaft and the requirement for this energy.

### SUMMARY OF THE INVENTION

According to a first aspect of the present invention there is provided an electronically controlled valve for a fluid-working machine, the valve comprising a valve body and a valve member moveable between a first position and a second position, wherein one of the first position and the second position is a position in which the valve is open and the other is a position in which the valve is closed, characterised in that the valve comprises a valve member moving mechanism operable to receive energy discontinuously from a reciprocator coupled to a rotatable shaft of a fluid-working machine to provide a valve member moving force to urge the valve member from the first position to the second position using the received energy.

The invention also extends to a fluid-working machine comprising a working chamber of cyclically varying volume, a manifold and a rotatable shaft, the working chamber being coupled to the rotatable shaft so that the volume of the working chamber varies cyclically with rotation of the rotatable shaft, characterised by a said electronically controlled valve arranged to regulate fluid flow between a said working chamber and a said manifold, and a reciprocator coupled to the rotatable shaft to reciprocate with rotation of the rotatable shaft and thereby provide a discontinuous source of energy to the valve member moving mechanism.

Thus, energy from the rotation of the rotatable shaft, received discontinuously from a reciprocator coupled to the rotatable shaft, is used to urge the valve member from the first position to the second position. This is typically more energy efficient than, for example, moving the valve member using only a solenoid, particularly where it is necessary to move the valve member against a substantial pressure difference or very rapidly. However, as the valve is electronically controlled, the valve retains some or all of the controllability of valves in which the valve member is moveable from a corresponding first position to a corresponding second position only by the action of a solenoid.

By a rotatable shaft we refer to a shaft which rotates during operation of the fluid working machine, the working chamber being coupled to the rotatable shaft so that the volume of the working chamber varies cyclically with rotation of the rotatable shaft in use. The rotatable shaft may be a crankshaft. The rotatable shaft may, for example, be coupled to the reciprocator by way of an eccentric cam, wobble plate or hollow cam, including a hollow cam having a roller cam follower.

Preferably, the valve member moving mechanism is operable to store energy received from a rotatable shaft of fluid-working machine by way of the reciprocator and to use said stored energy to provide the valve member moving force to urge the valve member from the first position to the second position.

Thus, energy received discontinuously from the rotation of the rotatable shaft is preferably stored and then used to urge the valve member from the first position to the second position. This allows the time of the movement of the valve from the first position to the second position to be controlled relative to the phase of rotatable shaft rotation. This addresses the problem that, otherwise, the availability of energy from the rotatable shaft may not coincide with the time when the valve is to be urged from the first position to the second position using energy received from the rotatable shaft.

Typically, the valve member moving mechanism comprises or consists of a first resilient component arranged to store energy received from a rotatable shaft of a fluid-working machine as elastic potential energy and to provide the valve member moving force using said stored elastic potential energy. The or each resilient component is typically an elastic member, for example, a spring. However, the resilient component may, for example, include a compressible fluid within a rigid body, for example a cylinder, or within a deformable body.

Elastic potential energy may be stored by compression or extension of the first resilient member, or both compression and extension, for example in embodiments where the first resilient component is an elastic member which is flexed in use.

Typically, energy received discontinuously from the reciprocator is received periodically. The reciprocator typically moves cyclically. Thus, the valve may comprise a valve member moving mechanism operable to receive energy periodically from a reciprocator coupled to a rotatable shaft of a fluid-working machine to provide a valve member moving force to urge the valve member from the first position to the second position using the received energy. The said reciprocator may be coupled to the rotatable shaft to reciprocate with rotation of the rotatable shaft and thereby provide a periodic source of energy to the valve member moving mechanism.

The valve moving mechanism may be operable to receive energy discontinuously (e.g. periodically) from the reciprocator during each cycle of reciprocator movement in which the valve is in a specific state, for example cycles in which the valve is closed or in which the valve is open. The valve moving mechanism may be operable to receive energy discontinuously (e.g. periodically) from the reciprocator at least during each cycle of reciprocator movement during which energy is not stored by the first resilient component which is sufficient to provide the valve member moving force using said stored elastic potential energy. The valve moving mechanism may be operable to receive energy from the reciprocator during each cycle of reciprocator movement. The cycles of reciprocator movement typically have the same period as a rotation of the rotatable shaft although alternative arrangements to drive a reciprocator at an integer multiple of the frequency of a rotatable shaft are known, such as a ring cam.

Typically, the electronically controllable valve is controllable to determine whether the valve member moves from the first position to the second position during a given period of time. For example, the electronically controllable valve may be controllable by a controller on a cycle by cycle basis to determine whether the valve member moves from the first position to the second position during a given period of time. It may be that the electronically controllable valve is controllable by a controller on a cycle by cycle basis to determine the time-averaged displacement of fluid between a low pressure manifold and a high pressure manifold of a fluid working machine. The electronically controllable valve may be controllable to determine when the valve member moves from the first position to the second position during a given period of time. However, it may be that when the valve member moves from the first position to the second position during a given period of time depends on factors such as the pressure difference across or flow past the valve member. Where the electronically controllable valve is provided in a fluid-working machine, the said given period of time typically corresponds to a particular cycle of working chamber volume, which typically coincides with an entire rotation of the rotatable shaft or an integer fraction of an entire rotation of the rotatable shaft. Typically, the reciprocator moves cyclically backwards and forwards and said given period of time corresponds with the period of a cycle of movement of the reciprocator.

Preferably, the electronically controlled valve further comprises an electronically controllable latch which is engageable when the valve member is in the first position. The electronically controllable latch is typically disengageable (and in some embodiments engageable) under the control of a fluid-working machine controller.

The electronically controllable latch may facilitate the storage of energy, for example, by retaining the valve member in a first position after a resilient component stores elastic potential energy. Importantly, engaging and disengaging a latch typically consumes very little energy. Furthermore, in contrast to solenoid actuated valves in which coil rise time limits the speed of operation, latches can typically be disengaged very quickly, minimising latency.

The electronically controllable latch may be operable on the valve member to prevent the valve member moving from the first position to the second position while the electronically controllable latch is engaged. However, the electronically controllable latch may be operable on the valve member moving mechanism to prevent the valve member moving mechanism from applying the valve member moving force to the valve member, or to reduce the magnitude of the valve member moving force, while the latch is engaged. Thus, when engaged, the latch may prevent a movement which could otherwise occur during at least one portion of the rotation of a rotatable shaft.

The latch may comprise an electromagnet which retains the valve member or which retains the valve member moving mechanism. The electronically controllable latch may comprise a permanent magnet operable to retain the valve member, or the valve member moving mechanism, when the valve member is in the first position, and an electromagnet operable to provide a force to overcome the attractive force of the permanent magnet to disengage the latch, or to provide an opposing magnetic field that reduces or eliminates the attractive force of the electromagnet.

In some embodiments, the valve member is biased from the first position to the second position by the first elastic member, and the electronically controllable latch (and, where relevant, the power supply to the electronically controllable latch) is capable of providing sufficient force to retain the valve member in the first position but not sufficient force to move the valve member from the second position to the first position against the first resilient component. Thus, much less electrical energy may be required to retain the valve member in the first position than would be required to move the valve member from the second position to the first position simply using an electromagnet.

The reciprocator and the valve member may be resiliently coupled through the first resilient component. The rotatable shaft may be a crankshaft comprising a crankshaft eccentric and the reciprocator may reciprocate with movement of the crankshaft eccentric. The reciprocator may be slidably mounted on or to the rotating shaft (for example, slidably mounted on a crankshaft eccentric). The reciprocator may comprise a pushrod. The reciprocator may in part define the working chamber. For example, the reciprocator may be a piston, or part thereof which in part defines the working chamber.

The valve member may be resiliently coupled to the reciprocator through the first resilient component. The reciprocator may be a part, for example, an end, of the first resilient component.

The valve, or a fluid working machine to which the valve is connected, may comprise phase altering means to cause the phase of the energy received discontinuously from the reciprocator to be different to the phase of cycles of working chamber volume.

Thus, the reciprocator may reciprocate with a different phase to cycles of working chamber volume. The coupling between the reciprocator and the valve moving mechanism may comprise phase altering means.

It may be that cycles of working chamber volume and the reciprocator are driven by the rotating shaft with different phases. For example, it may be that the rotating shaft is a crankshaft comprising a first crankshaft eccentric which determines cycles of working chamber volume (for example, which drives a reciprocating piston which forms part of a piston cylinder working chamber), and a second crankshaft eccentric which is angularly displaced from the first crankshaft eccentric and the reciprocator may be coupled to the second crankshaft eccentric. This provides an alternative or additional mechanism to allow for a time difference between the availability of energy from crankshaft eccentric which determines cycles of working chamber volume and the requirement for that energy to urge the valve member from the first position to the second position.

The first resilient component may extend between the valve body and the valve member. The first resilient component may extend between the reciprocator and the valve member. The valve moving mechanism may comprise a valve moving member and the first resilient component. The first resilient component may extend between the valve moving member and the reciprocator. The first resilient component may extend between the valve moving member and the valve body.

It may be that the first resilient component extends between the valve body and a valve moving member and the first resilient component is operable to provide the valve member moving force by exerting a force on the valve moving member so as to cause the valve moving member to exert the valve member moving force on the valve member, the valve further comprising a coupling (for example, a mechanical linkage) between the reciprocator and the valve moving member to store energy from the rotatable shaft as elastic potential energy in the first resilient component. Energy may be stored in the first resilient component independently of movement of the valve moving member or as a result of movement of the valve moving member from the second position to the first position.

The electronically controlled valve may further comprise an electronically controllable latch which is engageable to retain the valve moving member to prevent the valve moving member from providing the valve member moving force until the latch is released.

The electronically controlled valve may further comprise a second resilient component (for example, a second elastic member) operable to bias the valve member from the second position to the first position, or to bias the valve moving member to a position which enables the valve member to move from the second position to the first position. A coupling (for example a mechanical linkage) between the reciprocator and the valve moving member may store energy from the rotatable shaft as elastic potential energy in both the first resilient component and the second resilient component. In some embodiments, this enables the second resilient component to urge the valve moving member away from the valve member, to enable the valve member to move to the first position, prior to movement of the valve member from the first position to the second position. The second resilient component may extend between the valve body and the valve member. The second resilient component may extend between the valve body and the valve moving member. The second resilient component may extend between the valve moving member and the valve member.

In some embodiments, the first and second resilient components are different regions of the same component, such as different regions of the same elastic member. For example, the first resilient component may be the radially inward portion of a flat spring and the second resilient component may be the radially outward portion of the same flat spring, with the valve member attached to the flat spring between the first and second resilient components.

The reciprocator may comprise or be coupled to (for example by way of a mechanical linkage) a disengageable valve moving coupling operable to engage with the valve member to move the valve member from the second position to the first position and to subsequently disengage from the valve member to enable the valve member to move from the first position to the second position. The disengageable valve moving coupling may engage with a valve moving member, which may in turn engage with the valve member.

The reciprocator may comprise, or be mechanically linked to, a disengageable valve moving coupling which pulls the valve member in the same direction as the reciprocator (for example, to open the valve) when the reciprocator moves in one direction (for example, towards the rotatable shaft). In this case, preferably the electronically controllable valve comprises a first resilient component which stores energy as the valve member is moved from the second position to the first position, to subsequently urge the valve member from the first position to the second position. Typically, the valve member is disengageably latched in the first position. Typically, the disengageable valve moving coupling disengages from the valve member once the valve member has been latched in the first position.

The first resilient component may extend between the valve body and an armature coupled to or integral with the valve member. The disengageable latch may be operable to retain the armature so as to retain energy stored in the first resilient component when the valve member is moved from the second position to the first position and then to disengage so that the first resilient component urges the armature, and thereby the valve member which is coupled to or integral with the armature, from the first position to the second position.

The disengageable valve moving coupling typically engages mechanically with the valve member (directly or by engaging with a valve moving member which in turn engages with the valve member). For example, the disengageable valve moving coupling may comprise one or more detents or hooks on, or coupled to, the reciprocator, which engage with cooperating formations on the valve member, or valve moving member respectively. The disengageable valve moving coupling may form a reduced pressure cavity through which a force can be applied to the valve member, or valve moving member respectively. For example, the disengageable valve moving coupling may comprise a cavity defining member operable to sealedly contact the valve member, or valve moving member respectively, to form a cavity. The cavity defining member may be slidably mounted to a plunger coupled to the reciprocator which slides relative to the cavity defining member at the beginning of an expansion stroke of a working chamber reducing pressure within the cavity. The disengageable valve moving coupling may comprise a coupling surface which is brought into close proximity with a surface of the valve member, or valve moving member respectively, when the reciprocator moves in a first direction, towards the valve member, or valve moving member respectively, and which exerts a force on the valve member, or valve moving member respectively, when the reciprocator moves in a second direction by virtue of a squeeze film (of hydraulic liquid) or a reduction in the pressure of trapped fluid between the coupling surface and the said surface of the valve member, or valve moving member respectively when the reciprocator moves in a second direction, away from the valve member, or valve moving member, respectively.

The valve moving member is typically rigid. However, the valve moving member may be resilient. The first resilient component may be integral with the valve moving member. The valve moving member may be the first resilient component.

Typically, the valve is open in the said first position and closed in the said second position. Nevertheless, the valve member moving mechanism may also be useful to facilitate the opening of a valve under active control and so that valve may be closed in the said first position and open in the said second position

In some embodiments, the valve head moving mechanism begins to provide, or to increase, the valve head moving force as soon as energy from a rotating shaft of a fluid-working machine begins to be stored. However, it may also be that the valve head moving mechanism is operable to provide the valve head moving force only a period of time after storing energy received from a rotating shaft of a fluid-working machine, for example, in embodiments including an electronically controllable latch.

The valve member may be latched in the first position in use by a force arising from a fluid pressure differential across the valve member and the valve head moving force may oppose the force arising from a said fluid pressure differential.

The valve member may move from the first position to the second position in use responsive to a reduction in the force arising from a fluid pressure differential.

Typically, the electronically controlled valve is actively controlled and the energy is received from the rotatable shaft.

Typically, elastic potential energy received from the rotatable shaft is stored in the first resilient component each revolution of the rotatable shaft. In some embodiments elastic potential energy received from the rotatable shaft is stored in the first resilient component only on those revolutions of the rotatable shaft falling immediately after previously-stored elastic potential energy has been released, for example through the valve member moving from the first to the second position.

Typically, the rotatable shaft comprises an eccentric and the volume of the working chamber varies cyclically with the orientation of the eccentric. For example, the working chamber may be a piston cylinder having a piston which reciprocates within a cylinder and which is slidably mounted on the said eccentric.

It may be that the volume of the working chamber is defined by the orientation of a first said eccentric and the reciprocator follows a second said eccentric, axially displaced from and out of phase with (that is to say oriented at an angle to) the first said eccentric.

The fluid-working machine typically further comprises a controller wherein whether the valve member moves from the first position to the second position is determined by the controller on a cycle by cycle basis.

The fluid-working machine may, for example, be a radial piston machine. Cycles of working chamber volume may have the same period as rotations of the rotatable shaft. Cycles of working chamber volume may have a period which is a multiple of (typically an integer multiple), or a fraction (typically an integer fraction) of rotations of the rotatable shaft.

The fluid is typically a generally incompressible hydraulic liquid.

In some embodiments, energy from the rotatable shaft is transferred via working fluid compressed in the working chamber during a contraction stroke of a working chamber and stored in the first resilient component. Energy from the rotatable shaft is transferred via working fluid compressed in the working chamber during a contraction stroke of a working chamber and may be stored in the second resilient component. Energy stored in the second resilient component may be used to urge the valve member from the second position to the first position and concurrently to store energy in the first resilient component to subsequently urge the valve member from the first position to the second position. Energy from the rotatable shaft is transferred via working fluid compressed in the working chamber during a contraction stroke of a working chamber and may be stored in both the first and second resilient components.

For example, the valve may comprise a valve moving member connected to the valve member by the first or second resilient member. The valve moving element may be axially slidable relative to the valve member. The valve may comprise a restricted flow region into and out of which fluid flow is restricted, at least between the working chamber and the restricted flow region. The axially slidable valve moving element may have a first surface in fluid communication with the working chamber, for example in contact with a chamber which is in fluid communication with the working chamber. The axially slidable valve moving element may have a second surface which at least in part opposes the first surface and is in communication with the restricted flow region so that, when the pressure in the working chamber is higher than the pressure in the restricted flow region a net force is applied to the axially slidable valve member to move the same and thereby charge the first resilient member. The restricted flow region may be in fluid communication with a manifold, for example a low pressure manifold. Thus, when the pressure within the working chamber is sufficiently higher than the pressure within the restricted flow region, the axially slidable member moves, charging the first resilient member. The first resilient member then provides a valve moving force to urge the valve member from the first position to the second position. The movement of the axially slidable valve moving element may charge the second resilient member and the first resilient member. The valve member may be connected to the axially slidable valve moving element by the second resilient member and movement of the axially slidable valve moving element may charge the second resilient member, urging the valve member from the second position to the first position. Movement of the valve member from the second position to the first position may charge the first elastic member to subsequently urge the valve member from the first position to the second position.

Preferably, the valve member is not mechanically connected to an armature by a rigid or resilient connector such than an armature moves with the valve member between the first and second position. Armatures typically have significant mass and so, in contrast to known solenoid operated valves in which an armature is rigidly or resiliently connected to the valve member to provide a force to move the valve member, the mass of the valve member can be reduced, further reducing energy consumption and increasing speed of operation.

According to a second aspect of the present invention there is provided a method of operating an electronically controlled valve to regulate the flow of fluid between a working chamber of a fluid-working machine and a manifold, the valve comprising a valve body and a valve member moveable between a first position and a second position, wherein one of the first position and the second position is a position in which the valve is open and the other is a position in which the valve is closed, the method characterised by the step of receiving energy discontinuously from a reciprocator coupled to a rotating shaft of a fluid-working machine and providing a valve member moving force which acts to urge the valve member from the first position to the second position using said received energy.

The invention also extends to a method of operating a fluid-working machine comprising a working chamber of cyclically varying volume, a manifold, a rotatable shaft and a reciprocator, the working chamber being coupled to the rotatable shaft so that the volume of the working chamber varies cyclically with rotation of the rotatable shaft, the reciprocator coupled to the crankshaft, and an electronically controlled valve arranged to regulate fluid flow between a said working chamber and a said manifold, the valve comprising a valve body and a valve member moveable between a first position and a second position, wherein one of the first position and the second position is a position in which the valve is open and the other is a position in which the valve is closed, the method comprising operating the electronically controlled valve by the said method of operating an electronically controlled valve.

Thus, the invention also extends to a method of operating a fluid-working machine comprising a working chamber of cyclically varying volume, a manifold, a rotatable shaft and a reciprocator, the working chamber being coupled to the rotatable shaft so that the volume of the working chamber varies cyclically with rotation of the rotatable shaft, the reciprocator coupled to the crankhaft, and an electronically controlled valve arranged to regulate fluid flow between a said working chamber and a said manifold, the valve comprising a valve body and a valve member moveable between a first position and a second position, wherein one of the first position and the second position is a position in which the valve is open and the other is a position in which the valve is closed, characterised by the step of receiving energy from a rotating shaft of a fluid-working machine by way of the reciprocator and providing a valve member moving force which acts to urge the valve member from the first position to the second position using said received energy.

Preferably, the method comprises storing energy received from a or the rotating shaft of a fluid-working machine and using said stored energy to provide the work done by the valve member moving force to urge the valve member from the first position to the second position.

Preferably, the peak valve member moving force is provided subsequently to the peak power received from the rotating shaft of a fluid-working machine.

The fluid-working machine may comprise one or more further valves which may be electronically controlled valves. The fluid working machine controller may control the one or more further electronically controlled valves. For example, the electronically controlled valve may be a low pressure valve which regulates the flow of fluid between the working chamber and a low pressure manifold. The one or more further electronically controlled valve may comprise a high pressure valve which regulates the flow of fluid between the working chamber and a high pressure manifold.

The method may comprise providing a valve member moving mechanism which provides the valve moving force. The valve member moving mechanism may comprise or consist of a first resilient component and the method may comprise causing the first resilient component to store energy received from a rotating shaft of a fluid-working machine as elastic potential energy and providing the valve member moving force using said stored elastic potential energy.

The method preferably comprises the step, carried out by a fluid working machine controller, of determining whether the valve member should move from the first position to the second position during a given period of time. The method may comprise the step, carried out by a fluid working machine controller, of determining when the valve member should move from the first position to the second position during a specific cycle of working chamber volume.

The electronically controllable valve may be controlled by a controller on a cycle by cycle basis to determine whether the valve member moves from the first position to the second position during a given period of time. The electronically controllable valve may be controlled by a controller to determine when the valve member moves from the first position to the second position during a given period of time. However, it may be that when the valve member moves from the first position to the second position during a given period of time depends on factors such as the pressure difference across the valve member. It may be that the electronically controllable valve is controllable by a controller on a cycle by cycle basis to determine the time-averaged displacement of fluid between a low pressure manifold and a high pressure manifold of a fluid working machine.

The method may comprise the step of engaging an electronically controllable latch which when the valve member is in the first position. Typically, the method further comprises disengaging the latch under the control of a controller.

Energy may be stored in the first resilient component by exerting a force which acts on the valve member, the valve member exerting a force on the first resilient component.

The valve head moving force may be exerted on the valve member as soon as energy from a rotating shaft of a fluid-working machine begins to be stored. However, there may be a delay between energy first being stored in the first resilient component and the valve member moving force being exerted.

The method may comprise storing elastic potential energy from the rotatable shaft in the first resilient component each revolution of the rotatable shaft, or only on those revolutions of the rotatable shaft falling immediately after previously-stored elastic potential energy has been released, for example because of the valve member having been moved from the first to the second position.

Further optional features of the second aspect of the invention correspond to those discussed in respect of the first aspect of the invention.

### DESCRIPTION OF THE DRAWINGS

An example embodiment of the present invention will now be illustrated with reference to the following Figures in which:

FIG. 1 is a schematic diagram of a fluid-working machine;

FIG. 2 is a cross-section through an individual working chamber of a fluid-working machine; and

FIGS. 3A through 3C are cross-sections through an individual working chamber of a second example of a fluid-working machine, during a pumping cycle.

FIG. 4A is a cross-section through an individual working chamber of a fluid-working machine according to a third example; FIG. 4B is a detail illustrating the valve in the closed position before the opening spring is charged; FIG. 4C is a detail illustrating the valve in the closed position after the opening spring is charged, with the axially slidable rod latched in the first position;

FIG. 5 is a cross-section through an individual working chamber of a fluid-working machine according to a fourth example;

FIGS. 6A through 6C are cross-sections through an individual working chamber of a fluid-working machine according to a fifth example;

FIG. 7 is a cross-section through line A-A of FIG. 6A;

FIG. 8 is a cross-section through an individual working chamber of a fluid-working machine according to a sixth example;

FIG. 9 is a cross-section through an individual working chamber of a fluid-working machine according to a seventh example;

FIGS. 10A through 10E are schematic diagrams showing only key components of an individual working chamber of a fluid-working machine, in use, according to an eighth example; and

FIGS. 11A and 11B are cross-sections through a ninth example embodiment.

### DETAILED DESCRIPTION OF AN EXAMPLE EMBODIMENT

The invention relates to the field of electronically controlled valves which are suitable for regulating the flow of fluid between a manifold and a working chamber of a fluid-working machine which has a rotating shaft. In this example embodiment, valves according to the invention are used to regulate the flow of fluid between a low pressure manifold and a working chamber in a fluid-working machine of the type disclosed in EP 0 361 927, EP 0 494 236 and EP 1 537 333, the contents of which are incorporated herein by virtue of this reference. In the example embodiments, the rotating shaft is a crankshaft, however, one skilled in the art will appreciate that working chambers may be coupled to other rotating shafts, for example, they may be coupled to a wobble plate axle by way of a wobble plate.

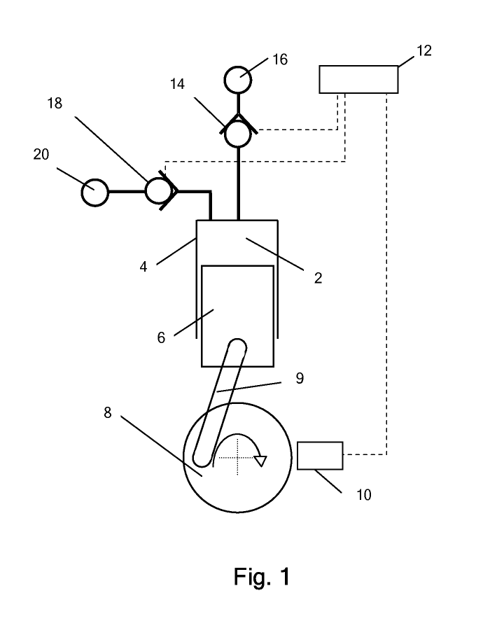

FIG. 1 is a schematic diagram of a fluid-working machine of this type. The net throughput of fluid is determined by the active control of electronically controllable valves, in phased relationship to cycles of working chamber volume, to regulate fluid communication between individual working chambers of the machine and fluid manifolds. Individual chambers are selectable by a controller, on a cycle by cycle basis, to either displace one of a number of predetermined volumes of fluid, including an infinite number of predetermined volumes of fluid, or to undergo an idle cycle with no net displacement of fluid, thereby enabling the net throughput of the pump to be matched dynamically to demand.

With reference to FIG. 1, an individual working chamber 2 has a volume defined by the interior surface of a cylinder 4 and a piston 6, functioning as the reciprocator, which is driven from a crankshaft 8 by a crank mechanism 9 and which reciprocates within the cylinder to cyclically vary the volume of the working chamber. A shaft position and speed sensor 10 determines the instantaneous angular position and speed of rotation of the shaft, and transmits shaft position and speed signals to a controller 12, which enables the controller to determine the instantaneous phase of the cycles of each individual working chamber. The controller is typically a microprocessor or microcontroller which executes a stored program in use.

The working chamber comprises an actively controlled low pressure valve in the form of an electronically controllable face-sealing poppet valve 14, which faces inwards toward the working chamber and is operable to selectively seal off a channel extending from the working chamber to a low pressure manifold 16. The working chamber further comprises a high pressure valve 18. The high pressure valve faces outwards from the working chamber and is operable to seal off a channel extending from the working chamber to a high pressure manifold 20.

At least the low pressure valve is actively controlled so that the controller can determine whether the lower pressure valve is actively opened, or in some embodiments, actively held open, during each cycle of working chamber volume. In some embodiments, the high pressure valve is actively controlled and in some embodiments, the high pressure valve is a passively controlled valve, for example, a pressure delivery check valve. The fluid-working machine may be a pump, which carries out pumping cycles, or a motor which carries out motoring cycles, or a pump-motor which can operate as a pump or a motor in alternative operating modes and can thereby carry out pumping or motoring cycles.

A full stroke pumping cycle is described in EP 0 361 927. During an expansion stoke of a working chamber, the low pressure valve is open and hydraulic fluid is received from the low pressure manifold. At or around bottom dead centre, the controller determines whether or not the low pressure valve should be closed. If the low pressure valve is closed, fluid within the working chamber is pressurised and vented to the high pressure valve during the subsequent contraction phase of working chamber volume, so that a pumping cycle occurs and a volume of fluid is displaced to the high pressure manifold. The low pressure valve then opens again at or shortly after top dead centre. If the low pressure valve remains open, fluid within the working chamber is vented back to the low pressure valve and an idle cycle occurs, in which there is no net displacement of fluid to the high pressure manifold.

In some embodiments, the low pressure valve will be biased open and will need to be actively closed by the controller if a pumping cycle is selected. In other embodiments, the low pressure valve will be biased closed and will need to be actively held open by the controller if an idle cycle is selected. The high pressure valve may be actively controlled, or may be a passively opening check valve.

A full stroke motoring cycle is described in EP 0 494 236. During a contraction stroke, fluid is vented to the low pressure manifold through the low pressure valve. An idle cycle can be selected by the controller in which case the low pressure valve remains open. However, if a full stroke motoring cycle is selected, the low pressure valve is closed before top dead centre, causing pressure to build up within the working chamber as it continues to reduce in volume. Once sufficient pressure has been built up, the high pressure valve can be opened, typically just after top dead centre, and fluid flows into the working chamber from the high pressure manifold. Shortly before bottom dead centre, the high pressure valve is actively closed, whereupon pressure within the working chamber falls, enabling the low pressure valve to open around or shortly after bottom dead centre.

In some embodiments, the low pressure valve will be biased open and will need to be actively closed by the controller if a motoring cycle is selected. In other embodiments, the low pressure valve will be biased closed and will need to be actively held open by the controller if an idle cycle is selected. Although the low pressure valve could potentially open passively, it typically opens under active control to enable the timing of opening to be carefully controlled. Thus, the low pressure valve may be actively opened, or, if it has been actively held open this active holding open may be stopped. As the low pressure valve typically has to open against a significant pressure difference, opening is typically active. The high pressure valve may be actively or passively opened. Typically, the high pressure valve will be actively closed.

In some embodiments, instead of selecting only between idle cycles and full stroke pumping and/or motoring cycles, the fluid-working controller is also operable to vary the precise phasing of valve timings to create partial stroke pumping and/or partial stroke motoring cycles.

In a partial stroke pumping cycle, the low pressure valve is closed later in the exhaust stroke so that only a part of the maximum stroke volume of the working chamber is displaced into the high pressure manifold. Typically, closure of the low pressure valve is delayed until just before top dead centre.

In a partial stroke motoring cycle, the high pressure valve is closed and the low pressure valve opened part way through the expansion stroke so that the volume of fluid received from the high pressure manifold and thus the net displacement of fluid is less than would otherwise be possible.

In each type of pumping or motoring stroke, energy is consumed in either actively opening, or actively closing, or actively holding open or closed one or both of the low pressure valve and the high pressure valve. In known valves this energy is provided by electromagnets. Energy consumption can be especially high during partial pumping or motoring strokes as, in each case, a valve must be closed rapidly whilst fluid is flowing through the valve. In a partial pumping stroke, the low pressure valve is closed while fluid is flowing out through the low pressure valve at a high velocity. In a partial motoring stroke, the high pressure valve must be closed while fluid is flowing through the high pressure valve at a high velocity.

The invention is particularly applicable where movement of the valve member from the first position to the second position is to occur when fluid is flowing past the valve member in a direction which is generally opposite the direction in which the valve member moves from the first position to the second position. More energy is typically required to move valve members in these circumstances as the flow of fluid past the valve member exerts forces on the valve member in the direction of fluid flow.

The precise timing of the opening and/or closing of the primary low pressure valve and the high pressure valve may also be varied in specific circumstances, such as start-up, operation while still relatively cold, and shut down of the device. Further details of these timing options are disclosed in EP 0 361 927, EP 0 494 236 and EP 1 537 333.

It is also possible that the fluid working machine may have manifolds which may function as either high or low pressure manifolds in alternative operating modes.

Fluid discharged from the fluid-working machine is typically delivered to a hydraulic line or pressure accumulator the compliance of which smoothes the output pressure and the time averaged throughput is varied by the controller on the basis of a demand signal received by the controller in the manner of the prior art.

### Example 1

In a first example embodiment a fluid working machine as described above includes a an electronically controlled valve 100 illustrated in schematic form in FIG. 2 as the low pressure valve.

The fluid-working machine comprises a rotating crankshaft 102 having a crankshaft eccentric 104, illustrated in cross-section in FIG. 2. A working chamber 106, of cyclically-varying volume, is defined by the interior of a cylinder 108, within which a piston 110 reciprocates. The piston is shown at top dead centre. The volume of the working chamber varies cyclically with the rotation of the crankshaft eccentric, and the movement of a piston shoe 112 which slidably engages with both the periphery of the crankshaft eccentric and the piston, and functions as the reciprocator.

The valve includes a poppet 114, functioning as the valve member, which is moveable between a closed position (shown), functioning as the second position, where it seals the working chamber from a low pressure manifold 16, 116, and an open position, functioning as the first position, where it allows the passage of fluid between the low pressure manifold and the working chamber. The valve also comprises a port 118 through which the working chamber can communicate with a high pressure manifold 20 (not shown in FIG. 2) and communication between the working chamber and the high pressure manifold is regulated by a high pressure valve (not shown in FIG. 2).

A closing spring 120, functioning as the first resilient component and as the valve moving mechanism, acts on the poppet and an opening member 122 connected to the poppet by a plurality of webs 123. The opening member is slidably mounted with the valve body and operable between a distal position where the closing spring is expanded and a proximal position where the closing spring is compressed. The opening member is biased to the proximal position by an opening spring 124. The opening member is made of a ferromagnetic material, such as steel, and comprises a flange 126 which can be retained against a ferromagnetic latch ring 128 when the opening member is at the end of its travel furthest towards the closing spring. An electromagnet coil 130 is in magnetic communication with the latch ring through a magnetic circuit element 132.

In use, the closing spring is compressed during each contraction stroke of the working chamber. The opening member may initially be latched in the proximal position, under the control of the controller, in which case the closing spring does not urge the poppet to the closed position. If and when the electromagnet is de-energised by the controller, and the closing spring is compressed sufficiently (by virtue of its design and the contemporaneous working chamber geometry) to overcome the opening spring, the opening member is no longer latched open and the compressed closing spring exerts a force to urge the poppet to the closed position. Thus, energy from the crankshaft has been stored and subsequently used to exert a force urging the poppet to the closed position.

Once the poppet valve has closed during an exhaust stroke, it will typically initially remain held shut by virtue of a pressure difference between the interior of the working chamber and the low pressure manifold. During a full stroke or part stroke motoring cycle, the valve will reopen when the pressure in the working chamber drops sufficiently after closure of the high pressure valve and the closing spring is sufficiently expanded. In a full stroke motoring cycle, this typically occurs near bottom dead centre where the closing spring is close to being fully extended. The valve arrangement of FIG. 2 is especially useful with a fluid working motor and would typically be combined with an actively controlled high pressure valve.

The valve arrangement of FIG. 2 is also useful in machines which can carry out part stroke pumping cycles as the latch can be released under the control of the controller at a desired point during an exhaust stroke to cause the low pressure valve to close. Part stroke motoring cycles may be carried out by careful choice of the properties of the two springs.

### Example 2

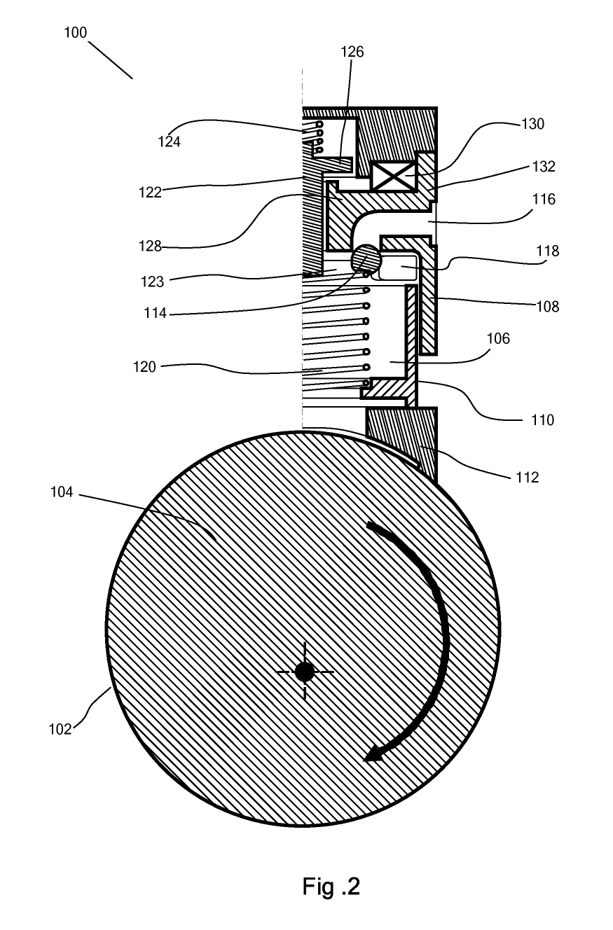

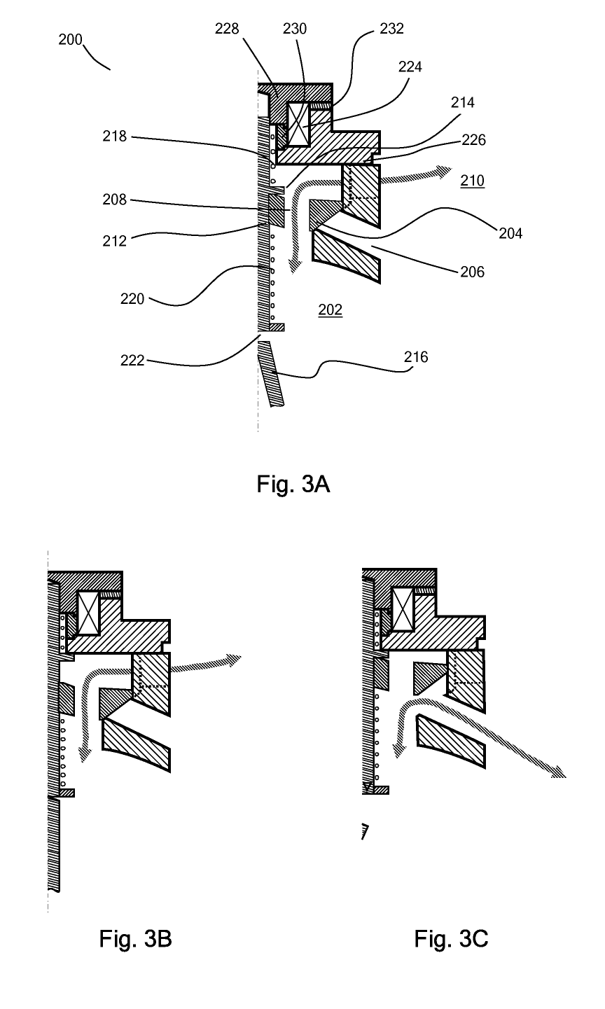

In a second example embodiment a fluid working machine as described above includes an electronically controlled valve 200 illustrated in schematic form in FIGS. 3A to 3C as the low pressure valve.

Electronically controlled valve 200 includes a piston-cylinder working chamber 202, a poppet 204 which is slidable between an open position (shown in FIG. 3C), functioning as the first position, where the low pressure manifold 16, 206 is in fluid communication with the working chamber volume, and a closed position (shown in FIGS. 3A and 3B), functioning as the second position, where the low pressure manifold is sealed from the working chamber. In this example, the poppet is an annular ring including an aperture 208 through which fluid can flow between the working chamber and the high pressure port 210 (extending to the high pressure manifold). A high pressure valve (not shown) regulates fluid communication between the high pressure port and the high pressure manifold 20.

The valve includes an axially slidable rod 212 (functioning as the valve moving member) which is slidable between a first position and a second position. The axially slidable rod has a first end (furthest from the crankshaft) and a second end (closest to the crankshaft) and a flange 214 located intermediate the first and second end of the axially slidable rod which can bear on the poppet. When the axially slidable rod is in the first position the poppet may be located in the first or second position or anywhere therebetween. When the axially slidable rod is in the second position, the poppet is limited to the second position.

A pin 216, functioning as the reciprocator, has a first end attached to the piston and a second end which discontinuously bears on the second end of the axially slidable rod. The first end of the axially slidable rod is connected to the body of the valve by a closing spring 218 (functioning as the first resilient component). A return spring 220 (functioning as the second resilient component) extends between the poppet and a flange 222 located towards the second end of the axially slidable rod.

The axially slidable rod is made from a magnetically permeable material. The valve includes an electromagnet coil 224 and, when the slidable rod is at the first end of its travel the flange contacts a first magnetic circuit member 226, enabling a magnetic circuit to be formed extending around the electromagnet through the first magnetic circuit member, the axially slidable rod, and a second magnetic circuit member 228. A non-magnetic sealing structure 230 is disposed between the first and second magnetic circuit members, within the electromagnet coil, to ensure that flux is directed through the axially slidable rod. A permanent magnet 232 is included between the first and second magnetic circuit members, externally of the electromagnet coil. The permanent magnet creates a magnetic field which can be overcome by supplying a suitable current to the electromagnet to generate an opposing magnetic field.

In operation, during a contraction stroke of the working chamber, the pin 216 contacts the second end of the axially slidable rod and pushes the axially slidable rod from the second position to the first position. As the axially slidable rod moves from the second position to the first position, the closing spring is charged, storing energy from the crankshaft. The axially slidable rod is latched in the first position by the magnetic field generated by the permanent magnet.

Movement of the axially slidable rod from the second position to the first position enables the poppet to move from the second position to the first position under the influence of the return spring, however, it may not do so immediately but may, for example, move only when the pressure difference between the working chamber and the low pressure manifold is sufficiently low that the forces acting on the poppet due to the pressure difference are less than the force exerted on the poppet by the return spring.

The controller can subsequently cause the poppet to be moved from the first position to the second position by causing a current to flow through the electromagnet to create a magnetic field in the opposite sense to the magnetic field created by the permanent magnet. The axially slidable rod exerts a valve moving force on the poppet valve, by virtue of the elastic potential energy stored in the closing spring and the action of the flange on the poppet, to cause the poppet valve to move from the first position to the second position. The axially slidable rod moves at the same time from the first position to the second position.

In this valve, the axially slidable rod, or the pin which extends from the piston, should include some compliance so that the rod seats against the latch mechanism but is not driven into it.

In this arrangement, the poppet can close without the axially slidable rod acting on the poppet, due to fluid flow past the poppet when in its first (open) position. This can be prevented by providing a further latch mechanism to latch the poppet, or arranging for the magnetic latch to retain both the axially slidable rod and the poppet.

The use of a permanent magnet which provides a magnetic field to create a latch mechanism is energy efficient. However, in alternative embodiments, the permanent magnet can be omitted in which case a current should be supplied to the electromagnet to retain the axially slidable rod in the first position.

Although the axially slidable rod is rigid in this example embodiment, the axially slidable rod could be resilient, in whole or in part. The closing spring might, for example, be integral to the axially slidable rod.

Thus, the invention has provided a mechanism by which energy from the crankshaft can be used to urge a valve member from a first position to a second position. This is typically more energy efficient than urging a valve member using only energy generated by an electromagnet.

Furthermore, the latency between the controller generating a signal to cause the valve member to move from the first position to the second position can be lower than with known valves as the time require to disengage a latch is significantly less than the current rise time of a solenoid suitable for providing all of the force required to open or close a valve.

### Example 3

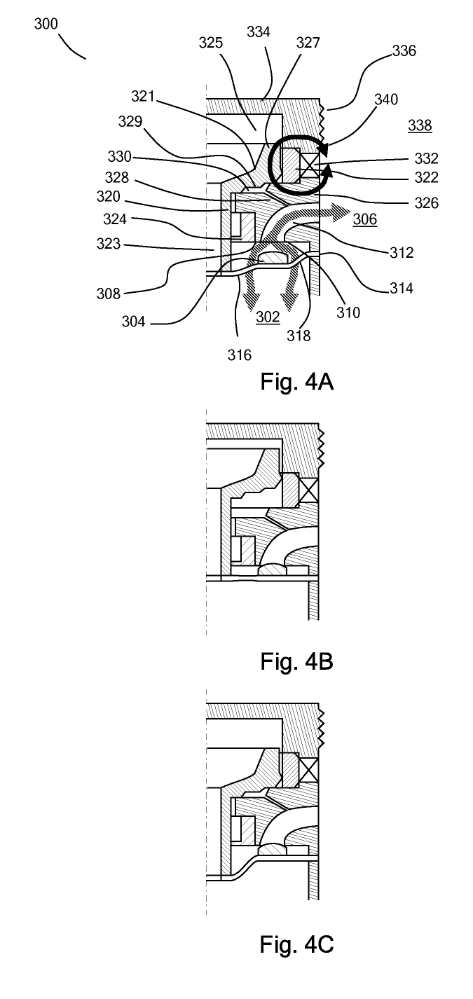

In a third example embodiment, a fluid working machine as described above includes an alternative electronically controlled valve 300 as the low pressure valve, illustrated in schematic form in FIGS. 4A through 4C.

Electronically controlled valve 300 is in communication with a working chamber 302, and comprises a poppet 304 which is slidable between an open position (shown in FIG. 4A), functioning as the first position, where the low pressure manifold 306 is in fluid communication with the working chamber volume and a closed position, functioning as the second position, where the poppet isolates the low pressure manifold from the working chamber. In this example, the valve member is an annular poppet making first and second line seals 308, 310 against the outlet 312 to the low pressure manifold. The valve also includes an outlet to a high pressure valve (not shown).

The poppet is connected by a flat spring 314 comprising an opening spring region 316 (functioning as the second resilient component) and a closing spring region 318 (functioning as the first resilient component) to a first end of an axially slidable rod 320 (functioning as the valve moving member). The flat spring has substantial fluid passages therethrough. The axially slideable rod has a radially extending flange 327, having an inner surface 321 and an outer surface 329 at a second end, and an axial bore 323 providing a path for fluid to flow between a working chamber and an inner chamber 325. The axially slidable rod is slidable on outer and inner bearings 322, 324 between a first position (shown in FIG. 4C) and a second position in which the rod is displaced inwards (upwards in FIG. 4B). The inner and outer bearings are held by a valve body 326 which includes a drain channel 328 providing a path for fluid to flow between the outlet to the low pressure manifold and a restricted flow region 330 formed between the outer surface of the axially slidable rod flange and the valve body. The outer bearing 322 of non-magnetic material isolates an electromagnet coil 332 from hydraulic fluid within the valve, and joins the valve body to a cap 334 which holds the valve in place through thread 336 which screws into the steel body of the fluid working machine 338.

In operation, the poppet is held open by the opening spring region providing an opening force exceeding the closing force provided by the closing spring region. The axially slidable rod is latched in the first position (FIG. 4C) by magnetic flux 340 from the coil passing through the axially slidable rod, the valve body, the cap, and the steel body of the fluid working machine. When the controller determines that the valve should be closed, it turns off the coil. The axially slidable rod moves inwards to its second position, the closing spring region moves the poppet to cover the outlet (FIG. 4B) and the opening spring region relaxes. Alternatively, a permanent magnet may be provided to latch the axially slidable rod in the first position and the magnetic flux provided by the permanent magnet may be overcome using an electromagnet to disengage the latch.

The working chamber contracts due to the inward movement of a reciprocating piston (not shown), pressure rises in the working chamber and fluid exits through the high pressure valve. High pressure fluid in the inner chamber acts on the inner surface of the axially slidable rod, but the inner and outer bearings restrict the flow of high pressure fluid into the restricted flow region. Thus, the pressure acting on the inner surface of the axially slidable rod flange exceeds the pressure acting on the outer surface, creating a net outwards force on the axially slidable rod. Any high pressure fluid leaking past the bearings into the restricted flow region can exit through the drain channel to the low pressure manifold. Thus, the axially slidable rod moves outwards until it seats in the first position, at which point the controller engages the electromagnet to latch the axially slidable rod in the first position after the working chamber pressure falls. During this movement, energy received discontinuously from the reciprocating movement of the piston, driven by the crankshaft, by way of the compression of fluid within the working chamber, is stored.

Now that the axially slidable rod is returned to its first position (FIG. 4C), the opening spring region provides a greater opening force on the poppet than the closing force provided by the closing spring, thereby providing a net outwards force that will open the valve (i.e. move the poppet to its first position) when the working chamber pressure falls as the working chamber expands past top dead centre.

In the present embodiment the fluid flow that resets the axially slidable rod into the first position passes through the centre of the valve on the upstroke of the working chamber to which the valve is associated. It would also be possible for the fluid to flow from a different reciprocating hydraulic source and/or through additional channels within or outside the valve.

By enabling energy to be stored and subsequently used to urge the valve member from the first position to the second position, force from the crankshaft can be used to move the valve member despite the timing differences between force availability and the requirement for that force, and only if on any particular stroke the force is actually required. For example, in a pumping cycle of a radial piston pump, force from the crankshaft is available during the contraction stroke of each working chamber. A spring compressed by this movement would have a peak of stored energy, and peak available force, at top dead centre. However, energy to urge the low pressure valve to the closed position is typically required close to bottom dead centre.

### Example 4

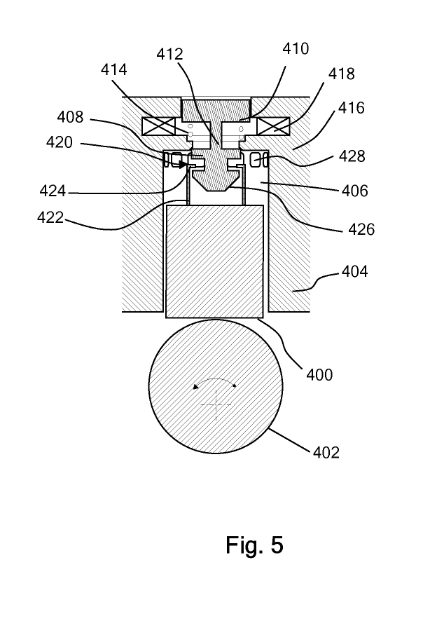

With reference to FIG. 5, a fourth example embodiment includes a piston 400 in sliding contact with a crankshaft eccentric 402. The piston reciprocates within a cylinder 404 and, with the cylinder, defines a working chamber 406 of cyclically varying volume. A valve assembly includes a poppet valve member 408 fixedly connected to an armature 410 by a valve stem 412. A closing spring 414, functioning as the first elastic component, is referenced to the valve body 416 and the armature. An electromagnet 418 is actuatable to provide magnetic flux to latch the armature against the valve body.

The poppet valve member includes one or more peripheral grooves 420 (for example, a circumferential groove) and the piston has arms 422 extending from the piston and having detents 424 at their distal ends to engage with the peripheral grooves when the poppet valve is in the closed position illustrated in FIG. 5 (functioning as the second position). The arms or detents, which together function as the disengageable valve moving coupling, are resilient. For example, they may be formed from thin sheets of metal. The poppet valve member has lead-in chamfers 426 to guide the arms into the peripheral grooves. Ports 428 are in communication with a high pressure check valve.

In use, when the valve is closed at top dead centre, the detents are engaged with the or each peripheral groove. As the piston begins to move towards bottom dead centre during an expansion stroke of the working chamber, the arms and detents drag the poppet valve to the open position (functioning as the first position). As the arms and/or detents are resilient, the detents may disengage from the poppet as the piston moves towards bottom dead centre. While the poppet is dragged from the closed position to the open position, the armature is brought into contact with the valve body, where it seats and is latched in place by magnetic flux from the electromagnet. This motion also charges the closing spring, storing energy received from the crankshaft discontinuously (during each expansion stroke) as elastic potential energy.

If the controller determines that the valve should remain open during a cycle of working chamber volume, the valve remains in the open position. When the controller determines that the valve should be closed, the current to the electromagnetic is switched off and the armature is released. The closing spring urges the valve from the open position to the closed position using the stored elastic potential energy.

Once the valve has closed, the detents will engage with the or each groove next time that the piston reaches top dead centre. Virtually no force is exerted on the poppet by this process owing to the lead-in chamfers.

The width of the grooves is selected to allow the piston to withdraw sufficiently to depressurize the working chamber before the valve is forced open, at the maximum operating pressure of the valve. Typically, the detents will enter the grooves slightly before top dead centre and engage fully with the poppet valve just after top dead centre, so that there is at least some compliance.

In this embodiment, the piston may require a strong spring or a retention mechanism to ensure that it follows the crankshaft eccentric. As before, the latch mechanism may alternatively employ a permanent magnet providing a holding force which is overcome by an electromagnet when the latch is to be disengaged.

### Example 5

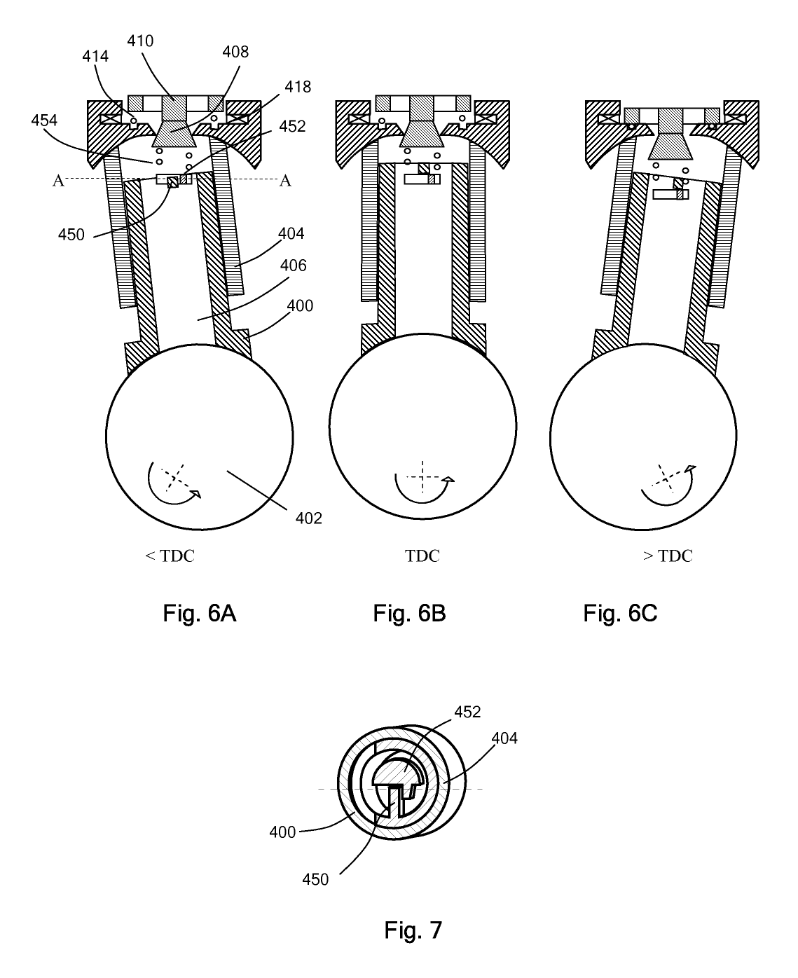

FIGS. 6A through 6C and FIG. 7 illustrate an example embodiment which operates on a similar principle to Example 5. However, instead of detents which engage with grooves in the valve head, a disengagable valve moving coupling is formed by a first pin 450 extending from the reciprocating piston to engage with a cooperating second pin 452, which functions as a valve moving member and which is itself coupled to the valve head by opening spring 454 (acting as the second resilient member). At top dead centre, the first pin is located inward of the second pin and, during an expansion stroke, the first pin bears outward onto the second pin, dragging the second pin outwards and thereby charging the opening spring which urges the valve head to the open position. The closing spring is compressed while the opening spring is stretched. The armature is latched to retain the valve in the open position and subsequently delatched under the control of the controller, whereupon the valve reopens by the action of the opening spring.

### Example 6

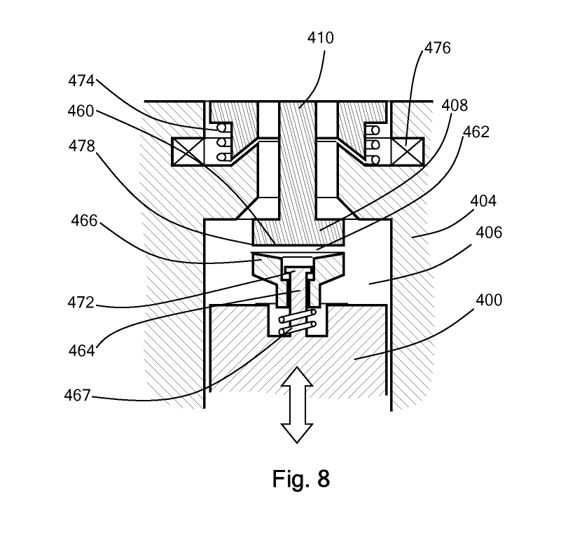

A disengageable valve moving coupling may operate other than by direct mechanical contact between the reciprocator and the valve member. In the example embodiment illustrated in FIG. 8, the valve member 408 has an outer surface 460 defining in part a cavity 462. A plunger 464 extends from the reciprocating piston to a cavity defining member 466 which is slidably mounted on the plunger and urged towards the valve member 408 by a strong spring 467. An end stop 472 on the plunger captures the cavity defining member. A closing spring 474 biases the armature 410 and the connected valve member closed, while an electromagnetic latch 476 controllably holds the valve open under the control of the controller.

Just before top dead centre, the cavity defining member approaches the valve member which may be open or closed. The cavity defining member slides outwards along the plunger for a defined travel while compressing the strong spring, venting fluid from the space between the cavity defining member and the valve member. The cavity defining member makes sealing contact with the outer surface of the valve member, around a sealing line 478, thereby sealing the cavity.

During the subsequent expansion stroke, the reciprocating piston moves outwards. The cavity defining member initially remains in sealed contact with the valve member and the pressure within the cavity drops further as the plunger slides relative to the cavity defining member. At the limit of its travel, the end stop pulls the cavity defining member which, due to the reduced pressure in the cavity relative to the pressure of surrounding working fluid, exerts a force on the valve member, pulling the valve member to the open position (the first position) if it was previously closed, where it is latched, while charging the opening spring (the first resilient member) as before, if it was previously extended.

In an alternative embodiment the cavity defining member may define a thin broad open cavity between the cavity defining member and the valve member, forming a squeeze film through which force can be exerted to open the valve.

### Example 7

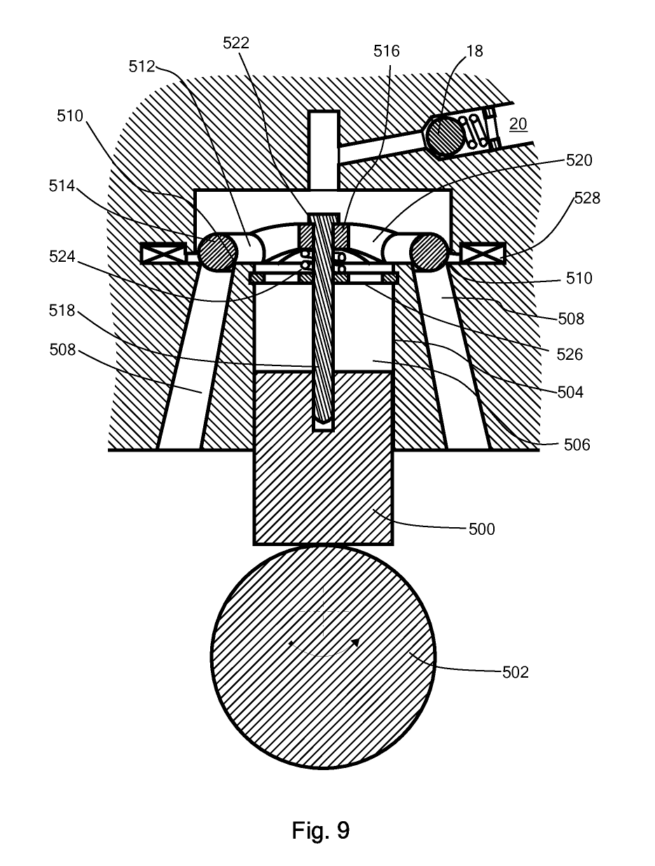

FIG. 9 illustrates an example embodiment in which the valve is necessarily moved to the first position (in this case closed) during each cycle of working chamber volume.

A piston 500 is in sliding contact with a crankshaft eccentric 502 and reciprocates within a cylinder 504 thereby defining a working chamber of cyclically varying volume 506. In this case, a plurality of outlets 508 extend to the low pressure manifold and the outlets have respective valve seats 510 sealable by an annular valve member 512. The annular valve member has an outer annulus 514 which engages with the valve seat, an inner annulus 516 which is slidably mounted on a valve stem 518, and a plurality of arms 520 connecting the inner annulus to the outer annulus and defining large apertures through which working fluid can flow. The arms are resilient, resulting in a slight compliance to facilitate sealing and allow for mechanical tolerances.

The valve stem is fixedly mounted to the piston and includes a flange 522 which engages with the inner annulus at least at bottom dead center and so limits the travel of the valve member along the valve stem. An opening spring 524 (functioning as the first resilient member) is registered between the annular valve member and a spring seat 526 fixedly mounted to the valve body and biases the annular valve member away from the spring seat, towards an open position. An electromagnet 528 is operable to provide a magnetic field.

In this embodiment, during each expansion stroke, the valve stem moves outwards with the piston and the flange engages with the inner annulus of the valve member, pulling it to the closed position shown in FIG. 9 and charging the opening spring. The controller may then latch the annular valve member in the closed position by passing a current through the electromagnet. During the subsequent contraction stroke, the valve stem slides inwards, through the valve member, while the valve member remains in the closed position unless the controller delatches the valve member, in which case the valve member opens due to the force exerted by the opening spring.

The opening spring should be sufficiently strong to overcome the slightly raised pressure in the working chamber at the beginning of each contraction stroke in the event that the controller does not decide that the valve should be latched. As with all other embodiments, the latch may alternatively be implemented using a permanent magnet which provides a latching force that is optionally overcome by an electromagnet under the control of the controller.

### Example 8

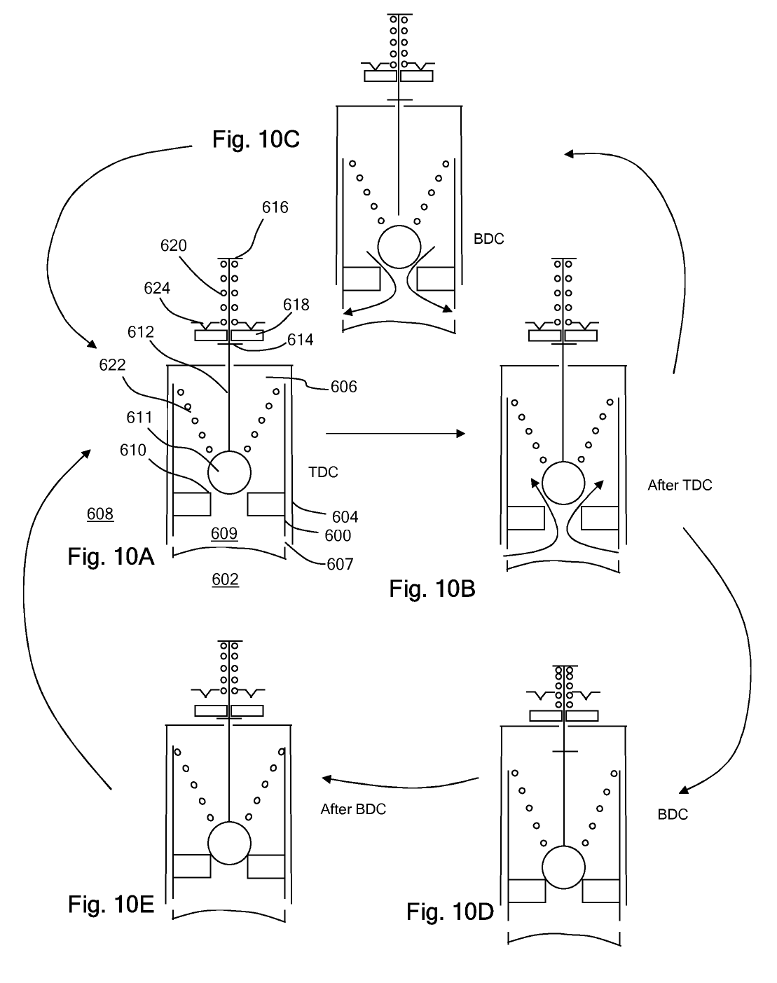

With reference to FIGS. 10A through 10E, in a further example a fluid working machine comprises a hollow piston 600 in sliding contact with a crankshaft eccentric 602 and reciprocating within a cylinder 604 thereby defining a working chamber of cyclically varying volume 606. The piston includes fluid paths 607 to allow fluid to flow freely between the low pressure manifold 608 surrounding the eccentric and the piston foot chamber 609.

A valve seat 610 is mounted within and reciprocates with the piston. A check ball valve head 611 is mounted on a sliding valve stem 612 which extends out of the working chamber and includes first and second endstops 614, 616, which define the limits of a travel of an armature 618. The valve assembly includes an opening spring 620 (functioning as the first resilient member) registered between the second end stop and the armature and a closing spring 622 registered between the piston and the valve head, biasing the valve head to the closed position.

In operation, at top dead centre, shown in FIG. 10A, the armature is in contact with a magnetically permeable member 624 and latched in place by magnetic flux generated by an electromagnet (not shown). The armature will have been forced into contact with, or very near to, the magnetically permeable member by the first endstop. The latched armature pulls the valve stem inwards (upwards in FIGS. 10A through E) and the opening spring is stronger than the closing spring in this configuration. During an expansion stroke the armature remains latched (FIG. 10B), the piston moves outwards but the valve remains open as the biasing force exerted by the opening spring remains stronger than the biasing force exerted by the closing spring. Fluid is able to flow through the valve into the working chamber. If the controller causes the armature to remain latched, the valve will remain open and the valve returns via the configuration shown in FIG. 10C to the configuration shown in FIG. 10A.

However, if the controller causes the electromagnet to be disengaged, the net forces exerted by the opening and closing spring cause the armature to move outwards, away from the magnetically permeable member, enabling the check ball valve to move outwards. During the contraction stroke, the valve seat will engage with the check ball valve (FIG. 10D), closing the valve and pumping working fluid out through a high pressure valve (not shown), thereby carrying out a pumping cycle and, at the same time, charging the opening spring. As the piston moves inwards, the first endstop again returns the armature towards the latched position (FIG. 10E). The valve will reopen when cylinder pressure falls early in the expansion stroke.

### Example 9

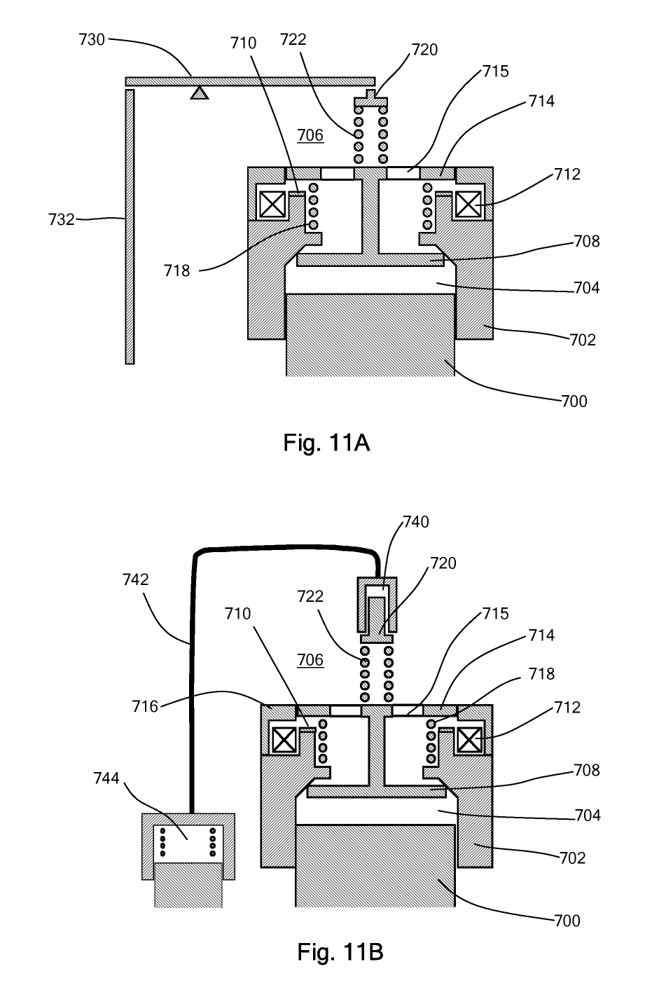

With reference to FIGS. 11A and 11B, in a further example a fluid working machine comprises a reciprocating piston 700 cyclically moved by an eccentric camshaft (not shown) which together with a cylinder 702 forms a working chamber 704, sealed from a low pressure manifold 706 by a valve member 708. A permanent magnet 710 is controllably defeated in use by an electromagnet 712 to release an armature 714, itself rigidly connected to the valve member and having fluid ports 715 therethrough, from a magnetic latch 716, allowing the valve to be closed by a closing spring 718 (acting as the first resilient member) acting on the armature. A valve moving member 720 acts on the armature through an opening spring 722 (acting as the second resilient member), in the direction of opening the valve.

In a first variant, shown in FIG. 11A, the valve moving member is driven by a rocker mechanism 730 and a pushrod mechanism 732 disengagably disposed against the camshaft and thereby driven to storage elastic potential energy in and thereby charge the opening spring only in the last portion of a contraction stroke of the working chamber. In use, the controller may defeat the permanent magnet latch by energising the electromagnet, causing the valve to close under the action of the closing spring and the working chamber to displace a volume of fluid into the high pressure manifold (not shown). In the last portion of the subsequent contraction stroke the pushrod moves the valve moving mechanism which compresses the opening spring which force, when the working chamber pressure has fallen after the end of the contraction stroke, overcomes the closing spring and reopens the valve.

In a second variant, shown in FIG. 11B, the valve moving member forms a moveable piston in a hydraulic cylinder 740 which is itself in fluid communication through channel 742 with a second hydraulic cylinder 744 disposed against the camshaft, the whole arranged to charge the opening spring it at least the last portion of a contraction stroke of the working chamber. In use, the controller may defeat the permanent magnet latch by energising the electromagnet, causing the valve to close under the action of the closing spring and the working chamber to displace a volume of fluid into the high pressure manifold (not shown). In the last portion of the subsequent contraction stroke the two hydraulic cylinders move the valve moving mechanism which compresses the opening spring which force, when the working chamber pressure has fallen after the end of the contraction stroke, overcomes the closing spring and reopens the valve.

Further variations and modifications may be made within the scope of the invention herein disclosed.

1. An electronically controlled valve for a fluid working machine, the valve comprising a valve body and a valve member moveable between a first position and a second position, wherein one of the first position and the second position is a position in which the valve is open and the other is a position in which the valve is closed, characterised in that the valve comprises a valve member moving mechanism operable to receive energy discontinuously from a reciprocator coupled to a rotating shaft of a fluid-working machine to provide a valve member moving force to urge the valve member from the first position to the second position using the received energy.

2. An electronically controlled valve according to claim 1, wherein the valve member moving mechanism is operable to store energy received from a rotating shaft of a fluid-working machine and to use said stored energy to provide the valve member moving force to urge the valve member from the first position to the second position.

3. An electronically controlled valve according to claim 1, wherein the valve member moving mechanism comprises or consists of a first resilient component arranged to store energy received from a rotating shaft of a fluid-working machine as elastic potential energy and to provide the valve member moving force using said stored elastic potential energy.

4. An electronically controlled valve according to claim 3, wherein the valve member is resiliently coupled to the reciprocator through the first resilient component.

5. An electronically controlled valve according to claim 1, wherein the valve member moving mechanism is operable to receive energy periodically from the reciprocator coupled to a rotating shaft of a fluid-working machine to provide the valve member moving force to urge the valve member from the first position to the second position using the received energy.

6. An electronically controlled valve according to claim 1, wherein the electronically controllable valve is controllable to determine whether the valve member moves from the first position to the second position during a given period of time.

7. An electronically controlled valve according to claim 1, wherein the electronically controlled valve further comprises an electronically controllable latch which is engageable when the valve member is in the first position.

8. An electronically controlled valve according to claim 7, wherein the electronically controllable latch comprises a permanent magnet operable to retain the valve member, or the valve member moving mechanism, when the valve member is in the first position, and an electromagnet operable to provide a force to overcome the attractive force of the permanent magnet to disengage the latch.

9. An electronically controlled valve according to claim 1, further comprising a second resilient component operable to bias the valve member from the second position to the first position, or to bias the valve moving member to a position which enables the valve member to move from the second position to the first position, wherein a coupling between the reciprocator and the valve moving member stores energy from a rotating shaft as elastic potential energy in both the first resilient component and the second resilient component.

10. An electronically controlled valve according to claim 1, wherein the reciprocator comprises or is coupled to a disengageable valve moving coupling operable to engage with the valve member, or a valve member moving member which engages with the valve member, to move the valve member from the second position to the first position and to subsequently disengage from the valve member, or the valve member moving member respectively, to enable the valve member to move from the first position to the second position.

11. An electronically controlled valve according to claim 1, wherein the valve comprises phase altering means to cause the phase of the energy received discontinuously from the reciprocator to be different to the phase of cycles of working chamber volume.

12. An electronically controlled valve according to claim 1, wherein the valve is open in the said first position and closed in the said second position.

13. A fluid-working machine comprising a working chamber of cyclically varying volume, a manifold and a rotatable shaft, the working chamber being coupled to the rotatable shaft so that the volume of the working chamber varies cyclically with rotation of the rotatable shaft, characterised by an electronically controlled valve according to claim 1 arranged to regulate fluid flow between a said working chamber and a said manifold, the valve member moving mechanism being coupled to the rotatable shaft so that the valve member moving mechanism receives energy discontinuously from a reciprocator coupled to the said rotatable shaft.

14. A fluid-working machine according to claim 13, further comprising a controller wherein the electronically controlled valve is actively controlled by the controller and whether the valve member moves from the first position to the second position is determined by the controller on a cycle by cycle basis.

15. A method of operating an electronically controlled valve to regulate the flow of fluid between a working chamber of a fluid-working machine and a manifold, the valve comprising a valve body and a valve member moveable between a first position and a second position, wherein one of the first position and the second position is a position in which the valve is open and the other is a position in which the valve is closed, the method characterised by the step of receiving energy discontinuously from a reciprocator coupled to a rotating shaft of a fluid-working machine and providing a valve member moving force which acts to urge the valve member from the first position to the second position using said received energy.

16. A method of operating a fluid-working machine comprising a working chamber of cyclically varying volume, a manifold, a rotatable shaft and a reciprocator, the working chamber being coupled to the rotatable shaft so that the volume of the working chamber varies cyclically with rotation of the rotatable shaft, the reciprocator being coupled to the rotatable shaft, and an electronically controlled valve arranged to regulate fluid flow between a said working chamber and a said manifold, the valve comprising a valve body and a valve member moveable between a first position and a second position, wherein one of the first position and the second position is a position in which the valve is open and the other is a position in which the valve is closed, characterised by the step of receiving energy discontinuously from the rotating shaft of a fluid-working machine by way of the reciprocator and providing a valve member moving force which acts to urge the valve member from the first position to the second position using said received energy.
